(19) United States
(12) Patent Application Publication
(10) Pub. No.: US 2026/0307971 A1
(43) Pub. Date: Oct. 8, 2026

(54) RING PULL CAN OPENING DEVICE

(71) Applicant: WORKEY LIMITED, Inworth, Colchester (GB)

(72) Inventors: Geoffrey ROLANDSEN, Inworth, Colchester (GB); Richard Banfield HICKS, KINGSTON UPON THAMES (GB)

(73) Assignee: WORKEY LIMITED, Inworth, Colchester (GB)

(21) Appl. No.: 19/476,942

(22) PCT Filed: Apr. 12, 2024
(86) PCT No.: PCT/EP2024/060003

§ 371 Date: Oct. 20, 2025

(30) Foreign Application Priority Data
Apr. 18, 2023 (GB) 2305683.1

(51) Int. Cl. B67B 7/40

(52) U.S. Cl. CPC B67B 7/406

(57) ABSTRACT

A ring pull can opening device comprises a handle (6), a fulcrum surface (7) at one end of B the handle with, preferably, a tongue (8) projecting from one end of the fulcrum surface for engagement under a ring pull tab (5) attached to a can lid (4). Rotating the handle (6) about the fulcrum surface (7) resting on the can lid (4) lifts the ring pull tab (5) to a first position wherein the ring pull tab punctures the connection between the lid and the can. A hook (9) projects from the same side of the handle as the tongue but spaced from the tongue (8) in a direction normal to the fulcrum surface (7) at said one end thereof. The hook (9) is engageable on the ring pull tab (5) when in the first position and the tongue (8) is in contact with the ring pull tab adjacent to the attachment point thereof to the lid (4). Rotating the handle (6) about the fulcrum surface (7) causes de-tachment of the lid (4) from the can (2).

### FIELD OF THE INVENTION

This invention relates to a ring pull can opening device.

### BACKGROUND TO THE INVENTION

Ring pull cans are usually intended to contain and preserve foodstuffs and are typically formed with an end panel or lid having a weakened periphery and a ring pull tab attached adjacent to one point on the periphery so that, pulling on the ring pull tab causes the lid to separate from the body of the can around the weakened periphery. The can is typically cylindrical with a generally circular lid, but other shapes are employed. The ring pull tab is normally located close to and parallel with the lid before use, and the first stage in removal of the lid is to lift the ring pull tab so that a portion of the tab punctures the lid, shearing across the weakened periphery at this point. The ring pull tab is then pulled across the lid in a direction away from the point of attachment of the tab to continue the shearing action around the periphery progressively separating the lid from the can.

There have been many proposals for ring pull can opening devices that exploit a simple lever principle to assist the user by reducing the force required to lift the tab, puncture the lid and peel it off in one motion. All the proposed devices are effectively levers which provide the user with a mechanical advantage sufficient for a person of average strength to remove a ring pull can lid. They employ a tongue to engage with the ring pull tab and a handle connecting to the tongue through a fulcrum point resting on the can lid such that pulling the handle in a direction away from the tongue applies a force to the tongue in a lever action around the fulcrum. As the ring pull tab and the lid are lifted, the fulcrum point tends to move towards the edge of the lid, which can tend to tip the can. This requires increasing strength in the user's opposite hand to hold the can still whilst utilising the device and removing the lid. Additionally, with some known devices, the lifting action can put increasing strain on the ring pull tab as the angle between the tab and the lid fluctuates during the lid removal process, particularly at the point of connection, increasing the risk of the ring pull tab snapping.

For some people with less than average strength, perhaps with arthritic wrists or hands, or with any type of reduced motor control, both the lifting of the ring pull tab and then the pulling to separate the lid can be difficult or impossible even with one of the known devices.

### SUMMARY OF THE INVENTION

According to the invention, there is provided a ring pull can opening device, comprising a handle having at one end thereof a linear surface extending at an angle, preferably an obtuse angle, to the handle at one side thereof, a curved fulcrum surface extending away from said linear surface to the other side of the handle, and a hook projecting from the linear surface at a position spaced along said linear surface from said fulcrum surface, the hook being engageable in use with a ring pull tab attached to a can lid when the ring pull tab has been raised from the can lid, whereby rotating the handle about the fulcrum surface with the linear surface located adjacent to the ring pull tab causes detachment of the lid from the can.

Other features of the invention are set out in the claims.

The configuration ensures that the fulcrum is much closer to the ring pull, in use, thereby significantly increasing mechanical advantage and thus the ease of use of the device. The distance between the upper side of the hook and the bottom face of the device preferably matches the length of the pull tab, in use, when the hook is engaged with the ring pull tab so as to enable the fulcrum of the lever to be located adjacent to (and as close as possible to) the hinge or point of attachment of the tab on the lid. This optimises the mechanical advantage of the arrangement. The ring pull tab is maintained at a substantially fixed angle to the lid during the lifting and peeling/separation operation, reducing the risk of snapping of the ring pull tab at or adjacent to the attachment point thereof on the lid.

### BRIEF DESCRIPTION OF THE DRAWINGS

In the drawings, which are perspective views illustrating an exemplary embodiment of the device of the invention, in use in removing a ring pull lid from a can:

FIG. 1 shows the preliminary stage before lifting the ring pull tab;

FIG. 2 shows the ring pull partially lifted;

FIG. 3 shows the engagement of the hook with the ring pull tab;

FIG. 4 shows the peeling back of the lid; and

FIG. 5 shows the position just prior to complete separation of the lid from the can.

### DETAILED DESCRIPTION OF THE ILLUSTRATED EMBODIMENT

It will be understood that the following description of the various elements of the device is with reference to the side view as illustrated in the drawings.

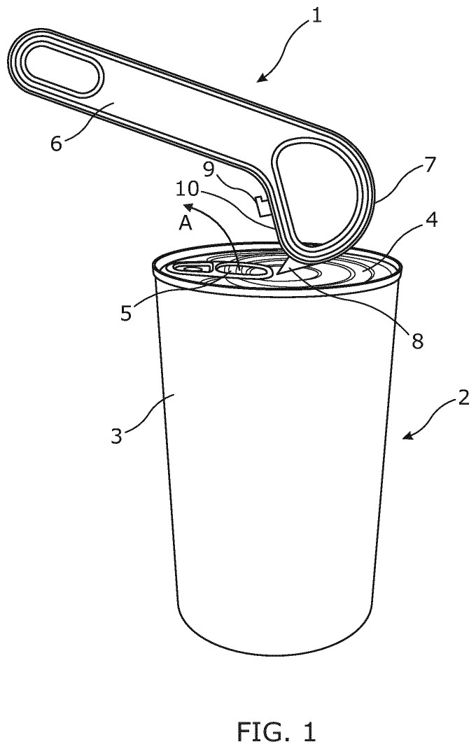

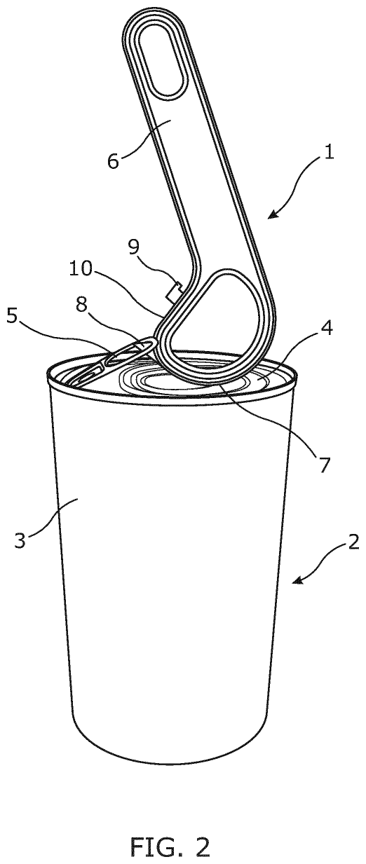

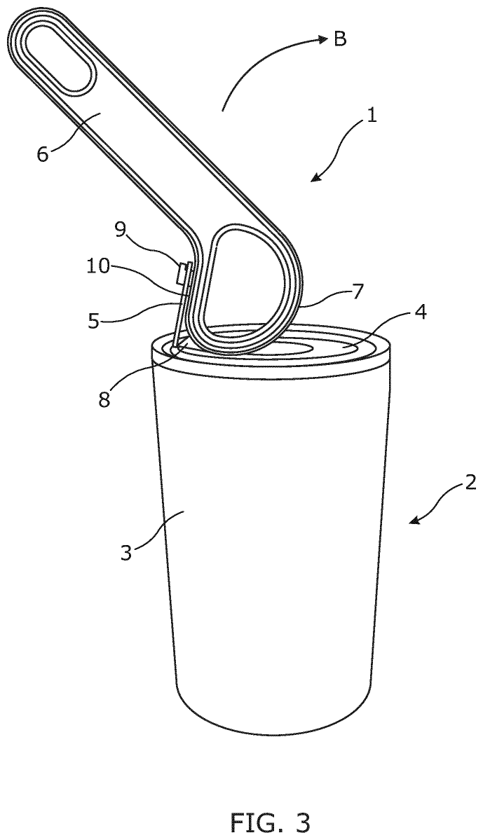

The Figures show the device 1 in use on a typical ring-pull can 2 having a hollow cylindrical body 3 with a lid 4 secured to one end thereof. The lid 4 has a circumferential score to provide a line of reduced strength along which the lid can separate from the can. The ring-pull tab 5 is connected to the lid at a position adjacent to the score line, typically by means of a rivet or weld. The device 1 comprises an integrally-moulded plastics body having a handle portion 6 provided at one end thereof with a curved fulcrum surface 7 having projecting from one end thereof a tongue 8 which has a wedge-shaped profile for insertion between the ring-pull tab 5 and the surface of the lid 4 of the can 2, as shown in FIG. 1. Pivoting the device around the fulcrum surface 7 away from the tab 5 whilst maintaining engagement of the tongue lifts the tab in the direction of arrow A, thereby causing the opposite end of the tab joined to the lid to press down into the can, breaking the score line at this point. The intermediate position in lifting the ring pull tab 5 is shown in FIG. 2. The user continues to rotate the device until the ring pull tab 5 has punctured the weakened periphery and the ring pull tab is raised sufficiently to make it easy for the user to insert the hook 9 through the ring pull tab 5. The position at this stage is illustrated in FIG. 3.

The device is provided with a hook 9 located on a surface 10 thereof which extends from the handle portion 6 in a direction which makes an angle, suitably an obtuse angle, therewith and leads into the curved fulcrum surface 7 at the region at which the tongue 8 extends therefrom. The hook 9 can be engaged with the ring-pull tab 5 with the fulcrum surface 7 in contact with the surface of the lid 4 and the tongue 8 in contact with the ring pull tab 5 at the connection point at which it is connected to the lid. The tongue 8 is configured such that the free end thereof which contacts the connection point is aligned with the hook 9 so that the horizontal distance between the hook 9 and the fulcrum point is as small as possible. This optimised configuration of the tongue 8 and hook 9 means that the fulcrum of the lever is as close as possible to the connection point of the ring pull tab 5. This has the advantage of optimising the mechanical advantage while minimising the tendency of the can to tip over as the handle rotates around the curved fulcrum surface.

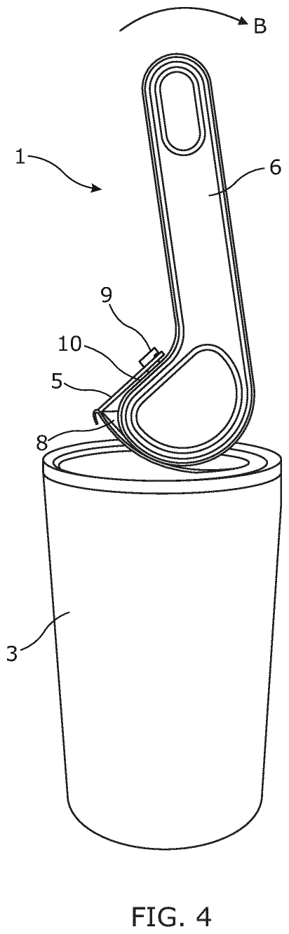

The handle portion 6 is then pulled in the direction of the arrow B so that the curved fulcrum surface 7 rolls across the surface of the lid 4 lifting the tab and thereby causing the lid 4 to peel back along the score line, as shown in FIG. 4. It should be noted that the angle between the lifted ring pull tab 5 and the surface of the lid 4 at the point of connection is held constant by the hook 9 and the tongue 8 in contact with the tab, thereby ensuring that there is no repeated flexing of the tab connection with the lid, which would induce the risk of fatigue in the metal leading to snapping of the tab from the lid. It will be understood that the angle between the ring pull tab and the can lid is only constant at or near the point of connection (rivet or weld) rather than across the entire lid, since this will bend and curl as the lid is peeled away from the can.

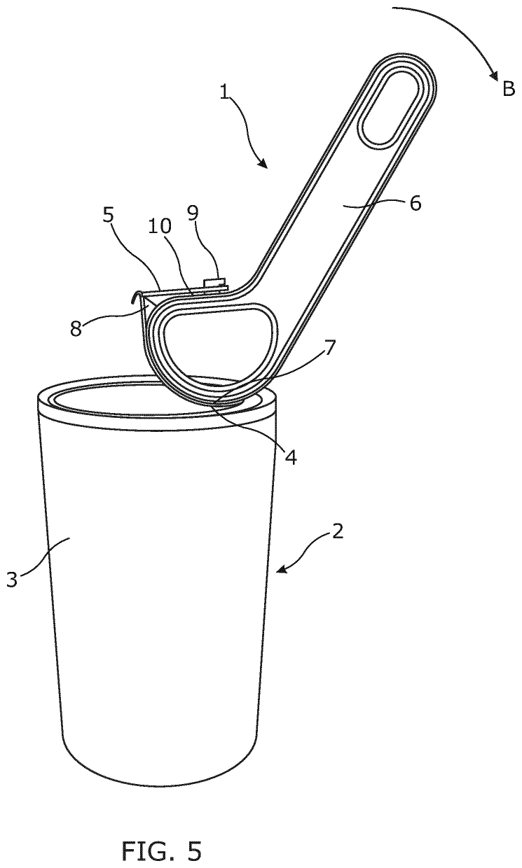

Continued rotation of the handle portion 6 around the fulcrum surface 7 continues to peel the lid 4 away from the can 2 until the point illustrated in FIG. 5 at which further rotation will separate the lid 4 from the can. The configuration of the curved fulcrum surface 7 is such that the hook 9 engaging the ring-pull tab 5 is kept as near as possible to the fulcrum point on the fulcrum surface at any given instant. This is achieved in part by forming the fulcrum surface with a curve whose centre approximates to the position of the hook 9. The fulcrum surface 7 can, however, be formed with a “D” shape, i.e. not necessarily uniformly of the same radius of curvature.

The optimal distance between the tongue 8/end of the fulcrum surface 7 and the hook will depend on the dimensions of the ring pull tab 5, so that the fulcrum point is positioned as close as is physically possible to the connection point of the ring pull tab 5 to optimise the mechanical advantage of the arrangement. For cans currently on the market at present, this distance is suitably 23-27 mm.

While the described embodiment is formed as a plastics moulding, suitably an injection moulding, it will be appreciated that the device can readily be formed or fabricated from other materials, such as metal.

What is claimed is:

1. A ring pull can opening device, comprising:
a handle having at one end thereof a linear surface extending at an angle to the handle at one side thereof;
a fulcrum surface curving away from said linear surface to the other side of the handle; and
a hook projecting from the linear surface at a position spaced from said fulcrum surface, the hook being engageable in use with a ring pull tab attached to a can lid when the ring pull tab has been raised from the can lid, whereby rotating the handle about the fulcrum surface with the linear surface located adjacent to the ring pull tab causes detachment of the lid from the can.

2. The ring pull can opening device of claim 1, further comprising a tongue projecting from an end of the fulcrum surface and outwardly of the linear surface for engagement under the ring pull tab, whereby rotating the handle about the fulcrum surface while the fulcrum surface is resting on the can lid lifts the ring pull tab to a first position wherein the ring pull tab punctures a connection between the lid and the can.

3. The ring pull can opening device of claim 2, wherein the tongue has a wedge shape in profile.

4. The ring pull can opening device of claim 2, wherein a distance between an upper side of the hook and a bottom face of the device matches a length of the ring pull tab, whereby, in use, when the hook is engaged with the ring pull tab, the tongue engages a connection between the ring pull tab and the can lid.

5. The ring pull can opening device of claim 1, wherein the fulcrum surface curves about a centre on the handle that is adjacent to the hook.

6. The ring pull can opening device of claim 1, formed as an integral plastics moulding.

7. The ring pull can opening device of claim 1, wherein the linear surface extends at an obtuse angle to the handle.
